(19) United States
(12) Patent Application Publication
(10) Pub. No.: US 2026/0214049 A1
(43) Pub. Date: Jul. 23, 2026

(54) DECENTRALIZED ARBITRATION CROSSBAR NETWORK

(71) Applicant: RDC Semiconductor Co., Ltd., Hsinchu City (TW)

(72) Inventors: Chun-Tse CHENG, Hsinchu City (TW); Chien-Zhi Chen, Hsinchu City (TW); Yu-Tsun Hsieh, Hsinchu City (TW); Wen-Jun Yen, Hsinchu City (TW)

(21) Appl. No.: 19/199,423

(22) Filed: May 6, 2025

(30) Foreign Application Priority Data
Jan. 23, 2025 (TW) 114102999

(51) Int. Cl. H04L 45/00

(52) U.S. Cl. CPC H04L 45/66

(57) ABSTRACT

A decentralized arbitration crossbar network is provided. The crossbar network is equipped with an arbitrating unit to configure a data path between circuits. After a three-way handshake process between two circuits is performed, the data path is established.

This application claims the benefit of Taiwan Patent Application No. 114102999, filed Jan. 23, 2025, the subject matter of which is incorporated herein by reference.

### FIELD OF THE INVENTION

The present invention relates to a crossbar network, and more particularly to a decentralized arbitration crossbar network.

### BACKGROUND OF THE INVENTION

As is well known, an IC chip includes a plurality of circuits. In addition, these circuits can transmit data and commands between each other. Correspondingly, a crossbar network is provided to transmit data and commands between circuits.

FIG. 1A is a schematic circuit block diagram illustrating the architecture of a conventional IC chip. The IC chip 100 is equipped with a first circuit 110, a second circuit 120, a third circuit 130 and a fourth circuit 140. The first circuit 110 includes a transmitter Tx1 and a receiver Rx1. The second circuit 120 includes a transmitter Tx2 and a receiver Rx2. The third circuit 130 includes a transmitter Tx3 and a receiver Rx3. The fourth circuit 140 includes a transmitter Tx4 and a receiver Rx4. Furthermore, each of the first circuit 110, the second circuit 120, the third circuit 130 and the fourth circuit 140 can receive data and commands from the other three circuits. For example, each of the first circuit 110, the second circuit 120, the third circuit 130 and the fourth circuit 140 is one of a control unit, a storage unit, a data processing unit and a graphic processing unit.

In order to realize the above relationship, the IC chip 100 is further equipped with an arbitrating unit to allocate the data paths between all the circuits 110, 120, 130, 140 to transmit data and commands. The arbitrating unit includes an arbitrator 150 and a plurality of multiplexers 151, 152, 153, 154.

The four input terminals of the first multiplexer 151 are respectively connected with the transmitters Tx1, Tx2, Tx3 and Tx4 of the four circuits 110, 120, 130 and 140. The output terminal of the first multiplexer 151 is connected with the receiver Rx1 of the first circuit 110. The select terminal of the first multiplexer 151 receives a first select signal S_{A}. The four input terminals of the second multiplexer 152 are respectively connected with the transmitters Tx1, Tx2, Tx3 and Tx4 of the four circuits 110, 120, 130 and 140. The output terminal of the second multiplexer 152 is connected with the receiver Rx2 of the second circuit 120. The select terminal of the second multiplexer 152 receives a second select signal S_{B}. The four input terminals of the third multiplexer 153 are respectively connected with the transmitters Tx1, Tx2, Tx3 and Tx4 of the four circuits 110, 120, 130 and 140. The output terminal of the third multiplexer 153 is connected with the receiver Rx3 of the third circuit 130. The select terminal of the third multiplexer 153 receives a third select signal S_{C}. The four input terminals of the fourth multiplexer 154 are respectively connected with the transmitters Tx1, Tx2, Tx3 and Tx4 of the four circuits 110, 120, 130 and 140. The output terminal of the fourth multiplexer 154 is connected with the receiver Rx4 of the fourth circuit 140. The select terminal of the fourth multiplexer 154 receives a fourth select signal S_{D}.

The arbitrator 150 is connected with four circuits 110, 120, 130 and 140. The arbitrator 150 and the first circuit 110 exchange link information with each other according to a first communication signal C₁. The arbitrator 150 and the second circuit 120 exchange link information with each other according to a second communication signal C₂. The arbitrator 150 and the third circuit 130 exchange link information with each other according to a third communication signal C₃. The arbitrator 150 and the fourth circuit 140 exchange link information with each other according to a first communication signal C₄. Furthermore, the arbitrator 150 is used to configure the data paths between the circuits 110, 120, 130 and 140 according to the link information of the four communication signals C₁, C₂, C₃ and C₄.

FIG. 1B schematically illustrates the operations of the conventional IC chip. For example, according to the four communication signals C₁, C₂, C₃ and C₄, the arbitrator 150 determines that data and commands are transmitted between the first circuit 110 and the second 120. The arbitrator 150 also determines that data and commands are transmitted between the third circuit 130 and the fourth circuit 140.

Meanwhile, the arbitrator 150 uses the first select signal S_{A} to control the first multiplexer 151 to establish the data path, and thus the transmitter Tx2 of the second circuit 120 is connected with the receiver Rx1 of the first circuit 110. Similarly, the arbitrator 150 uses the second select signal S_{B} to control the second multiplexer 152 to establish the data path, and thus the transmitter Tx1 of the first circuit 110 is connected with the receiver Rx2 of the second circuit 120. Similarly, the arbitrator 150 uses the third select signal S_{C} to control the third multiplexer 153 to establish the data path, and thus the transmitter Tx4 of the fourth circuit 140 is connected with the receiver Rx3 of the third circuit 130. Similarly, the arbitrator 150 uses the fourth select signal S_{D} to control the fourth multiplexer 154 to establish the data path, and thus the transmitter Tx3 of the third circuit 130 is connected with the receiver Rx4 of the fourth circuit 140.

After all data paths have been established, the arbiter 150 notifies the four circuits 110, 120, 130 and 140 through the communication signals C₁, C₂, C₃ and C₄. Consequently, the four circuits 110, 120, 130 and 140 start to transmit data and commands. In other words, the four circuits 110, 120, 130 and 140 can transmit data and commands to the desired circuits through the established data paths.

Furthermore, if the data path needs to be changed, the arbitrator 150 can establish other data paths at an appropriate time. If the first circuit 110 intends to transmit data and commands to the third circuit 130, the first circuit 110 will notify the arbitrator 150 through the communication signal C₁. After the third circuit 130 confirms that the data and commands from the first circuit 110 can be received, the third circuit 130 will notify the arbitrator 150 through the communication signal C₃. Meanwhile, the arbitrator 150 initiates the arbiter 150 uses the third select signal S_{C} to control the third multiplexer 153 to establish a new data path. After the new data path is established, the arbitrator 150 notifies the first circuit 110 to transmit the data and commands to the third circuit 130 through the communication signal C₁.

Generally, the data transmission inside an IC chip is realized by using a crossbar network. FIG. 2 schematically illustrates the architecture of a conventional crossbar network. The crossbar network includes an arbitrating unit 260, a plurality of transmitters Tx1, Tx2, Tx3, Tx4, Tx5, Tx6, and a plurality of receivers Rx1, Rx2, Rx3, Rx4, Rx5, Rx6. Like the architecture FIG. 1A, the transmitter Tx1 and the receiver Rx1 are included in a first circuit (not shown), the transmitter Tx2 and the receiver Rx2 are included in a second circuit (not shown), . . . , and so on. In FIG. 2, six transmitters Tx1, Tx2, Tx3, Tx4, Tx5, Tx6 and six receivers Rx1, Rx2, Rx3, Rx4, Rx5, Rx6 are presented herein for illustration. It is noted that the number of the transmitters and the number of the receivers are not restricted. That is, the number of the transmitters and the number of the receivers in the crossbar network may be varied according to the practical requirements.

The arbitrating unit 260 includes an arbitrator 250 and a plurality of multiplexers 251, 252, 253, 254, 255 and 256. The input terminals of the multiplexer 251 are connected with the transmitters Tx1, Tx2, Tx3, Tx4, Tx5 and Tx6. The output terminal of the multiplexer 251 is connected with the receiver Rx1. The select terminal of the multiplexer 251 receives a select signal S. The input terminals of the multiplexer 252 are connected with the transmitters Tx1, Tx2, Tx3, Tx4, Tx5 and Tx6. The output terminal of the multiplexer 252 is connected with the receiver Rx2. The select terminal of the multiplexer 252 receives the select signal S. The rest may be deduced by analogy. The input terminals of the multiplexer 256 are connected with the transmitters Tx1, Tx2, Tx3, Tx4, Tx5 and Tx6. The output terminal of the multiplexer 256 is connected with the receiver Rx6. The select terminal of the multiplexer 256 receives the select signal S.

Furthermore, the select signal S contains a plurality of sub-select signals for controlling corresponding multiplexers 251, 252, 253, 254, 255 and 256. In other words, the arbitrator 250 initiates the select signal S to control the multiplexers 251, 252, 253, 254, 255 and 256 to establish a plurality of data paths between the transmitters Tx1, Tx2, Tx3, Tx4, Tx5, Tx6 and the receivers Rx1, Rx2, Rx3, Rx4, Rx5, Rx6. Similarly, the arbitrator 250 exchanges link information with the transmitters Tx1, Tx2, Tx3, Tx4, Tx5, Tx6 and the receivers Rx1, Rx2, Rx3, Rx4, Rx5, Rx6 according to communication signals (not shown). Consequently, the data paths are determined.

As mentioned above, the conventional crossbar network requires the arbitrating unit 260 to configure all data paths. Furthermore, in order to establish a new data path, the arbitrator 250 needs to implement coordination and allocation again.

Furthermore, as the numbers of transmitters and receivers in the crossbar network increase, the number of communication lines increases. Consequently, the internal connection design of the IC chip becomes more complicated.

Alternatively, the communication signals can be transmitted between the transmitters Tx1, Tx2, Tx3, Tx4, Tx5, Tx6 and the receivers Rx1, Rx2, Rx3, Rx4, Rx5, Rx6 through a shared communication line. Under this circumstance, the arbitrator 250 sequentially exchanges link information with the transmitters Tx1, Tx2, Tx3, Tx4, Tx5, Tx6 and the receivers Rx1, Rx2, Rx3, Rx4, Rx5, Rx6 in a polling manner. Since it is time-consuming for the arbitrator 250 to exchange link information with the transmitters Tx1, Tx2, Tx3, Tx4, Tx5, Tx6 and the receivers Rx1, Rx2, Rx3, Rx4, Rx5, Rx6 in the polling manner, the operating performance of the crossbar network is deteriorated.

### SUMMARY OF THE INVENTION

An embodiment of the present invention provides a crossbar network. The crossbar network includes a first circuit, a second circuit, a first bus, a second bus, a first multiplexing device, a second multiplexing device, a first link detecting device and a second link detecting device. The first circuit includes a first transmitter and a first receiver. The second circuit includes a second transmitter and a second receiver. The first bus is connected to the first transmitter of the first circuit. The second bus is connected to the second transmitter of the second circuit. The first multiplexing device is connected to the second bus. The first receiver of the first circuit is coupled to the second bus through the first multiplexing device. The second multiplexing device is connected to the first bus. The second receiver of the second circuit is coupled to the first bus through the second multiplexing device. The first link detecting device is coupled to the second bus. When the second circuit initiates a link request to the first circuit, the first link detecting device detects the link request and notifies the first circuit through the second bus. The second link detecting device is coupled to the first bus. When the first circuit initiates the link request to the second circuit, the second link detecting device detects the link request and notifies the second circuit through the first bus.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A (prior art) is a schematic circuit block diagram illustrating the architecture of a conventional IC chip;

FIG. 1B (prior art) schematically illustrates the operations of the conventional IC chip;

FIG. 2 (prior art) schematically illustrates the architecture of a conventional crossbar network;

FIG. 3A schematically illustrates the architecture of a crossbar network according to an embodiment of the present invention;

FIG. 3B is a flowchart illustrating an operation process of the initiator in the crossbar network of the present invention;

FIG. 3C is a flowchart illustrating an operation process of the target in the crossbar network of the present invention;

FIG. 4 schematically illustrates a simplified version of the architecture of the crossbar network shown in FIG. 3A; and

FIG. 5 schematically illustrates the architecture of a crossbar network according to another embodiment of the present invention.

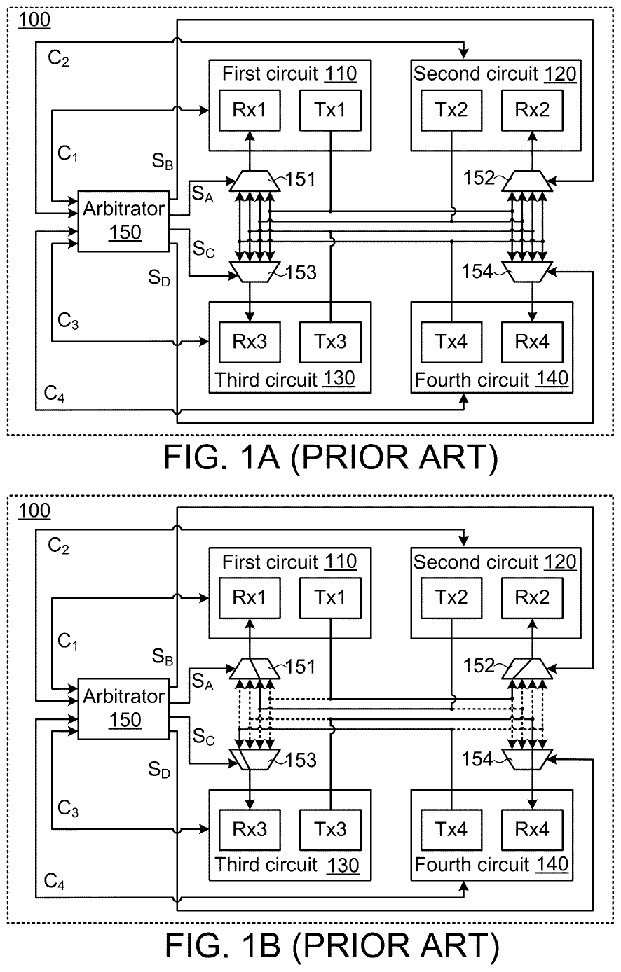

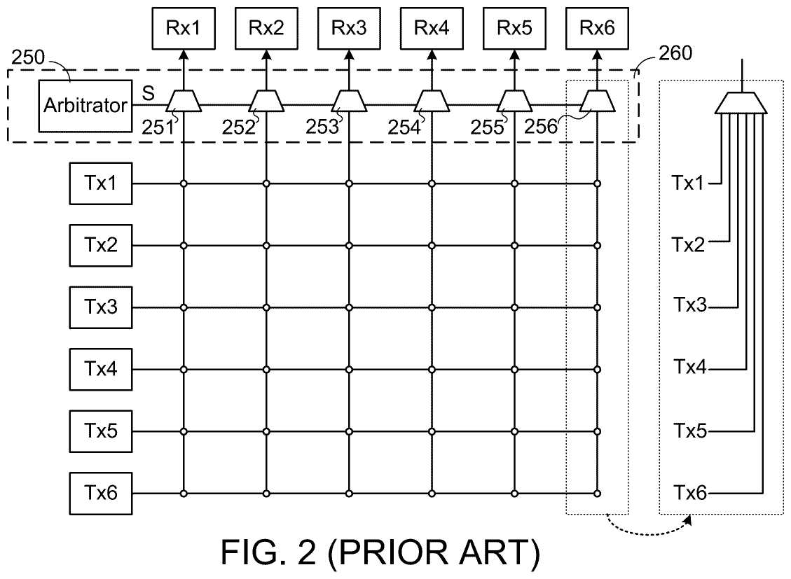

### DETAILED DESCRIPTION OF PREFERRED EMBODIMENTS

The present invention proposes a decentralized arbitration crossbar network. In accordance with a feature of the present invention, the crossbar network is not equipped with an arbitrating unit to configure a data path. Instead, after a three-way handshake process between two circuits is performed, the data path is established. In other words, a link can be established after the three-way handshake process between two circuits is performed.

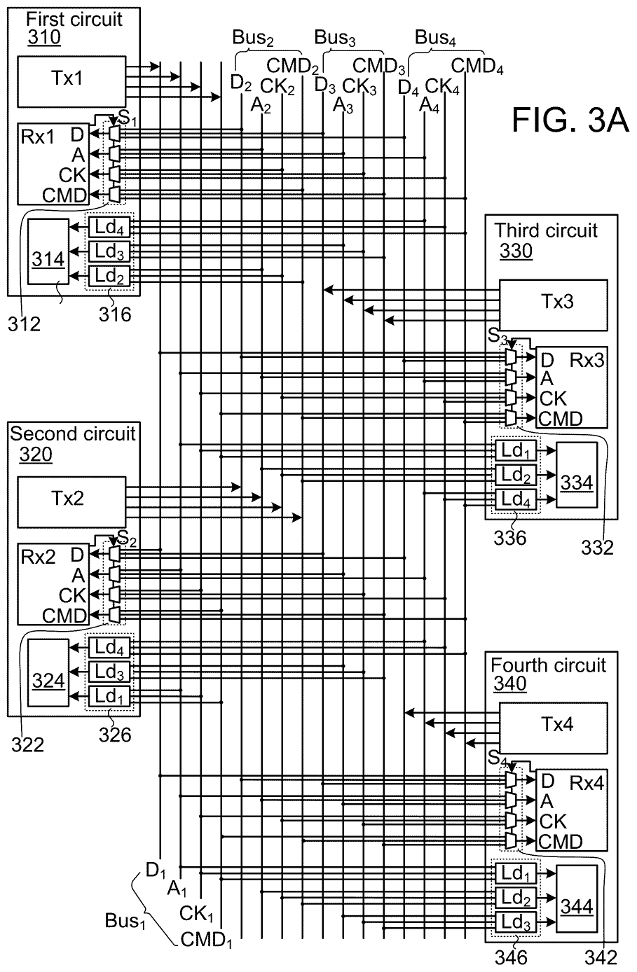

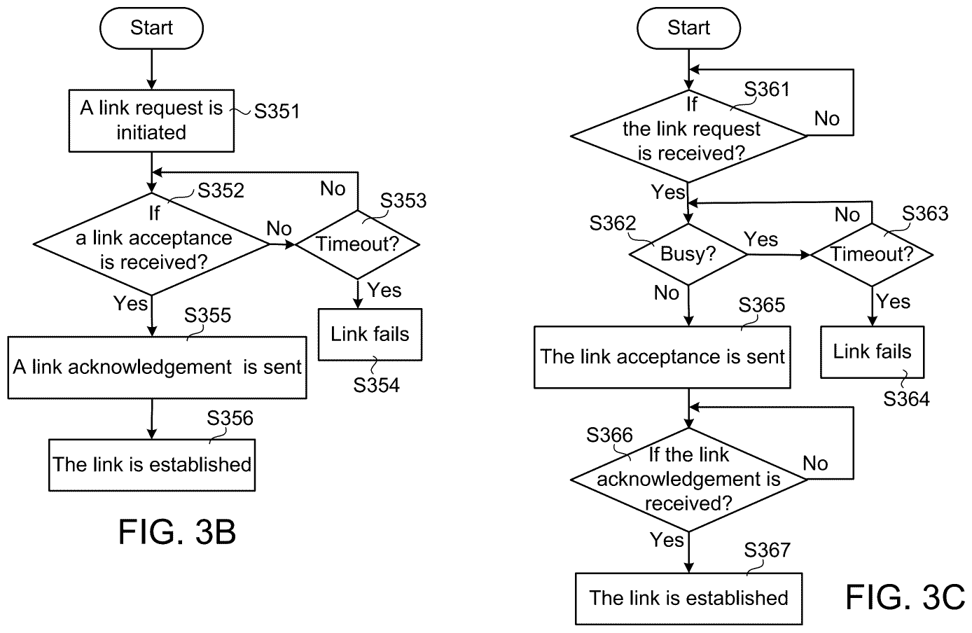

FIG. 3A schematically illustrates the architecture of a crossbar network according to an embodiment of the present invention. The crossbar network is designed in an IC chip. In an embodiment, the crossbar network includes a first circuit 310, a second circuit 320, a third circuit 330 and a fourth circuit 340. Each of the first circuit 310, the second circuit 320, the third circuit 330 and the fourth circuit 340 corresponds to a unique address. In other words, the addresses of the first circuit 310, the second circuit 320, the third circuit 330 and the fourth circuit 340 are different.

The first circuit 310 includes a link allocation device 314, a transmitter Tx1 and a receiver Rx1. The second circuit 320 includes a link allocation device 324, a transmitter Tx2 and a receiver Rx2. The third circuit 330 includes a link allocation device 334, a transmitter Tx3 and a receiver Rx3. The fourth circuit 340 includes a link allocation device 344, a transmitter Tx4 and a receiver Rx4.

The first circuit 310 further includes a multiplexing device 312 and a link detecting device 316. The second circuit 320 further includes a multiplexing device 322 and a link detecting device 326. The third circuit 330 further includes a multiplexing device 332 and a link detecting device 336. The fourth circuit 340 further includes a multiplexing device 342 and a link detecting device 346. The multiplexing devices 312, 322, 332 and 342 and the link detecting devices 316, 326, 336 and 346 may be respectively designed outside the circuits 310, 320, 330 and 340.

For example, each of the circuits 310, 320, 330 and 340 is one of a control unit, a storage unit, a processing unit, a graphics processing unit, or the like. The crossbar network in FIG. 3A includes four circuits 310, 320, 330, 340 only. It is noted that the number of circuits in the crossbar network is not restricted. That is, the number of circuits in the crossbar network is greater than or equal to 2.

Furthermore, the transmitter of each circuit is connected to the corresponding bus, and the signals sent by each circuit are transmitted through the corresponding bus. As shown in FIG. 3A, the transmitter Tx1 of the first circuit 310 is connected to a first bus Bus₁, the transmitter Tx2 of the second circuit 320 is connected to a second bus Bus₂, the transmitter Tx3 of the third circuit 330 is connected to a third bus Bus₃, and the transmitter Tx4 of the fourth circuit 340 is connected to a fourth bus Bus₄.

The signals from the transmitter Tx1 of the first circuit 310 contain a data signal D₁, an address signal A₁, a clock signal CK₁ and a command signal CMD₁, and these signals are transmitted through the first bus Bus₁. The signals from the transmitter Tx2 of the second circuit 320 contain a data signal D₂, an address signal A₂, a clock signal CK₂ and a command signal CMD₂, and these signals are transmitted through the second bus Bus₂. The signals from the transmitter Tx3 of the third circuit 330 contain a data signal D₃, an address signal A₃, a clock signal CK₃ and a command signal CMD₃, and these signals are transmitted through the third bus Bus₃. The signals from the transmitter Tx4 of the fourth circuit 340 contain a data signal D₄, an address signal A₄, a clock signal CK₄ and a command signal CMD₄, and these signals are transmitted through the fourth bus Bus₄.

Furthermore, the receiver of each circuit is coupled to all non-corresponding buses through the corresponding multiplexing device. Consequently, the receiver can be coupled to one of the non-corresponding buses by controlling the multiplexing device. For example, the receiver Rx1 of the first circuit 310 is coupled to the second bus Bus₂, the third bus Bus₃ and the fourth bus Bus₄ through the multiplexing device 312. Similarly, the receiver Rx2 of the second circuit 320 is coupled to the first bus Bus₁, the third bus Bus₃ and the fourth bus Bus₄ through the multiplexing device 322. Similarly, the receiver Rx3 of the third circuit 330 is coupled to the first bus Bus₁, the second bus Bus₂ and the fourth bus Bus₄ through the multiplexing device 332. The receiver Rx4 of the fourth circuit 340 is coupled to the first bus Bus₁, the second bus Bus₂ and the third bus Bus₃ through the multiplexing device 342. In some other embodiments, the multiplexing devices 312, 322, 332 and 342 can also be integrated into the corresponding receivers Rx1, Rx2, Rx3 and Rx4.

For example, the multiplexing device 312 in the first circuit 310 includes four multiplexers. According to a select signal S₁, four signals from a specified bus are transmitted to the receiver Rx1 through the four multiplexers. That is, the receiver Rx1 uses the select signal S₁ to control the multiplexing device 312, and thus the receiver Rx1 is coupled to one of the second bus Bus₂, the third bus Bus₃ and the fourth bus Bus₄ according to the select signal S₁. If the first circuit 310 decides to be couple to the second bus Bus₂ corresponding to the second circuit 320, the receiver Rx1 of the first circuit 310 uses the select signal S₁ to control the four multiplexers in the multiplexing device 312. Consequently, the receiver Rx1 receives the data signal D₂, the address signal A₂, the clock signal CK₂ and the command signal CMD₂ from the second bus Bus₂. These signals are outputted from the transmitter Tx2 of the second circuit 320. Similarly, if the first circuit 310 decides to be coupled to the fourth bus Bus₄ corresponding to the fourth circuit 340, the receiver Rx1 of the first circuit 310 uses the select signal S₁ to control the four multiplexers in the multiplexing device 312. Consequently, the receiver Rx1 receives the data signal D₄, the address signal A₄, the clock signal CK₄ and the command signal CMD₄ from the fourth bus Bus₄. These signals are outputted from the transmitter Tx4 of the fourth circuit 340. The control methods of the receivers Rx2, Rx3 and Rx4 in the other circuits 320, 330 and 340 are similar to the control method of the first circuit 310, and not redundantly described herein.

Furthermore, the link detecting device of each circuit is connected to all non-corresponding buses. The link detecting device is used to detect whether any other circuit initiates a link request and notify the link allocation device. For example, the link detecting device 316 of the first circuit 310 is connected to the second bus Bus₂, the third bus Bus₃ and the fourth bus Bus₄. Similarly, the link detecting device 326 of the second circuit 320 is connected to the first bus Bus₁, the third bus Bus₃ and the fourth bus Bus₄. Similarly, the link detecting device 336 of the third circuit 330 is connected to the first bus Bus₁, the second bus Bus₂ and the fourth bus Bus₄. Similarly, the link detecting device 346 of the fourth circuit 340 is connected to the first bus Bus₁, the second bus Bus₂ and the third bus Bus₃.

For example, the link detecting device 316 of the first circuit 310 is connected to the second bus Bus₂, the third bus Bus₃ and the fourth bus Bus₄ to detect whether the second circuit 320, the third circuit 330 or the fourth circuit 340 initiates the link request. In an embodiment, a link detector Ld₂ of the link detecting device 316 is connected to the second bus Bus₂, a link detector Ld₃ of the link detecting device 316 is connected to the third bus Bus₃, and a link detector Ld₄ of the link detecting device 316 is connected to the fourth bus Bus₄.

When the second circuit 320 initiates a link request to the first circuit 310, the link detector Ld₂ of the first circuit 310 confirms that the second circuit 320 initiates the link request according to the address signal A₂, the clock signal CK₂ and the command signal CMD₂ on the second bus Bus₂, and then the link detecting device 316 notifies the link allocation device 314 of the first circuit 310. Similarly, when the fourth circuit 340 initiates a link request to the first circuit 310, the link detector Ld₄ of the first circuit 310 confirms that the fourth circuit 340 initiates the link request according to the address signal A₄, the clock signal CK₄ and the command signal CMD₄ on the fourth bus Bus₄, and then the link detecting device 316 notifies the link allocation device 314 of the first circuit 310. Of course, the link detecting device 326, 336 and 346 of the other circuits 320, 330 and 340 can detect the link request. The operations of the link detecting device 326, 336 and 346 of the circuits 320, 330 and 340 are similar to those of the first circuit 310, and not redundantly described herein.

In an embodiment, the link allocation device 314 in the first circuit 310 can set a link priority to determine the order of establishing links between the first circuit 310 and other circuits 320, 330 and 340. For example, since the link detecting device 316 of the first circuit 310 is connected to the second bus Bus₂, the third bus Bus₃ and the fourth bus Bus₄, the three link detectors Ld₂, Ld₃ and Ld₄ in the link detecting device 316 can receive link requests from the other three circuits 320, 330 and 340 at the same time. According to the setting of the link priority, the link allocation device 314 can determine the order of establishing the links between the first circuit 310 and the other circuits 320, 330 and 340. In an embodiment, each of the link allocation devices 314, 324, 334 and 344 sets the link priority. Furthermore, the link allocation devices 314, 324, 334 and 344 in the circuits 310, 320, 330 and 340 can appropriately modify the corresponding link priority according to the actual operation status.

It is noted that numerous modifications may be made while retaining the teachings of the present invention. For example, in a variant example, the link detecting devices 316, 326, 336 and 346 are respectively integrated into the link allocation devices 314, 324, 334 and 344. In another variant example, the link detecting devices 316, 326, 336 and 346 and link allocation devices 314, 324, 334 and 344 are respectively integrated into the receivers Rx1, Rx2, Rx3 and Rx4. Alternatively, the link allocation devices 314, 324, 334 and 344 in the circuits 310, 320, 330 and 340 are omitted. Under this circumstance, the sequence of establishing the link between the circuits can be determined according to a preset sequence.

In the above embodiment, the link detecting device 316 of the first circuit 310 detects whether any of the other circuits initiates the link request according to the address signal, the clock signal and the command signal. It is noted that numerous modifications may be made while retaining the teachings of the present invention. For example, in another embodiment, link detecting device 316 of the first circuit 310 detects whether any of the other circuits initiates the link request according to the address signal and the command signal only.

FIG. 3B is a flowchart illustrating an operation process of the initiator in the crossbar network of the present invention. FIG. 3C is a flowchart illustrating an operation process of the target in the crossbar network of the present invention. The initiator can be any of the circuits 310, 320, 330 and 340 in the crossbar network. The target can be any of the circuit 310, 320, 330 and 340 in the crossbar network. Furthermore, the initiator will not issue a link request to itself. In the following description, the second circuit 320 is used as the initiator, and the first circuit 310 is used as the target.

Please refer to FIG. 3B again. When the second circuit 320 intends to establish the link with the first circuit 310, the second circuit 320 initiates a link request (Step S351). In addition, the link request is transmitted from the second circuit 320 through the second bus Bus₂.

When the link request is initiated, the clock signal CK₂ on the second bus Bus₂ is activated under control of the transmitter Tx2 of the second circuit 320. In addition, the address signal A₂ contains the address of the first circuit 310, and the command signal CMD₂ contains a synchronous message (SYC). Afterwards, the receiver Rx2 of the second circuit 320 uses the control signal S₂ to control the multiplexer 322, so that the receiver Rx2 is coupled to the first bus Bus₁.

Please refer to FIG. 3B again. Then, the second circuit 320 determines whether a link acceptance from the first circuit 310 is received (step S352), and the first circuit 310 transmits the link acceptance through the first bus Bus1. Before timeout (Step S353), the second circuit 320 continues to wait for the link acceptance from the first circuit 310. If the link acceptance is still not received after a certain time period, i.e., after timeout (Step S353), the second circuit 320 confirms that the link fails (step S354).

After the link fails, the second circuit 320 can continue to initiate a link request to the first circuit 310. For example, the second circuit 320 may adjust the setting of the link priority in the link allocation device 324 to increase the link priority of the first circuit 310 and initiate the link request again. Of course, the number of initiating the link request by the second circuit 320 is limited. If the number of initiating the link request by the second circuit 320 and the link still fails, the second circuit 320 reports that the link fails and stops initiating the link request.

Furthermore, in the process of waiting for the link acceptance, the receiver Rx2 of the second circuit 320 or the link detector Ld₁ of the link detecting device 326 receives the clock signal CK₁, the address signal A₁ and the command signal CMD₁ from the first bus Bus₁. According to the clock signal CK₁, the link detector Ld₁ decodes the address signal A₁ and the command signal CMD₁. When the second circuit 320 confirms that the address signal A₁ contains the address of the second circuit 320 and the command signal CMD₁ contains the synchronous acceptance message (SYC ACPT), the second circuit 320 confirms that the first circuit 310 sends the link acceptance.

Please refer to FIG. 3B. After the link acceptance is received (Step S352), the second circuit 320 sends a link acknowledgement (Step S355), and the link acknowledgement is transmitted to the first circuit 310 through the second bus Bus₂.

After the link acknowledgement is issued, the clock signal CK₂ on the second bus Bus₂ is activated under control of the transmitter Tx2 of the second circuit 320. In addition, the address signal A₂ contains the address of the first circuit 310, and the command signal CMD₂ contains a synchronous acknowledge message (SYC ACK). Consequently, the first circuit 310 can receive the link acknowledgement from the second circuit 320.

Please refer to FIG. 3B again. After the link acknowledgement is issued, it means that the link between the second circuit 320 and the first circuit 310 has been established (Step S356). Meanwhile, the second circuit 320 can start to transmit data and commands to the first circuit 310 through the second bus Bus₂.

When the link is established, the receiver Rx1 of the first circuit 310 uses the select signal S₁ to control all multiplexers in the multiplexing device 312, and thus the data signal D₂, the address signal A₂, the clock signal CK₂ and the command signal CMD₂ are transmitted to the receiver Rx1 through the second bus Bus₂. Consequently, the data and the commands of the second circuit 320 can be outputted from the transmitter Tx2 and transmitted to the receiver Rx1 of the first circuit 310 through the second bus Bus₂. Furthermore, in order to terminate the connection, the second circuit 320 only needs to send a link termination to the first circuit 310 to terminate the link.

Please refer to FIG. 3C. The first circuit 310 can receive the link requests from other circuits 320, 330 and 340 at any time (Step S361). For example, in the first circuit 310, the link detector Ld₂ of the link detecting device 316 receives the clock signal CK₂, the address signal A₂ and the command signal CMD₂ from the second bus Bus₂. According to the clock signal CK₂, the link detector Ld₂ decodes the address signal A₂ and the command signal CMD₂. After the first circuit 310 confirms that the address signal A₂ contains the address of the first circuit 310 and the command signal CMD₂ contains a synchronous message (SYC), the first circuit 310 confirms that the second circuit 320 has initiates a link request. Similarly, the link detector Ld₃ of the first circuit 310 can judge whether the third circuit 330 has initiated a link request through the third bus Bus₃. Similarly, the link detector Ld₄ of the first circuit 310 can judge whether the fourth circuit 340 has initiated a link request through the fourth bus Bus₄.

As mentioned above, the link detecting device 336 of the third circuit 330 and the link detecting device 346 of the fourth circuit 340 are also connected to the second bus Bus₂. However, since the address signal A₂ contains the address of the first circuit 310, the link detecting device 336 of the third circuit 330 and the link detecting device 346 of the fourth circuit 340 will ignore (don't care) this link request.

Please refer to FIG. 3C again. When the first circuit 310 is in a busy state (step S362) for more than a certain time, i.e., a timeout (step S363), the first circuit 310 cannot issue a link acceptance, indicating a link failure (step S364). Meanwhile, the first circuit 310 may adjust the setting of the link priority in the link allocation device 314 to increase the link priority of the second circuit 320. When the first circuit 310 is not in the busy state (Step S362), the first circuit 310 sends the link acceptance (step S365), and the first circuit 310 transmits the link acceptance through the first bus Bus₁.

When the link acceptance is issued, the clock signal CK₁ on the first bus Bus₁ is activated under control of the transmitter Tx1 of the first circuit 310. In addition, the address signal A₁ contains the address of the second circuit 320, and the command signal CMD₁ contains the synchronous acceptance message (SYC ACPT). Afterwards, the receiver Rx1 of the second circuit 310 uses the control signal S₁ to control the multiplexing device 312, so that the receiver Rx1 is coupled to the second bus Bus₂.

Please refer to FIG. 3C again. Then, the first circuit 310 waits for the link acknowledgment (Step S366). While waiting for the link acknowledgment, the receiver Rx1 of the first circuit 310 or the link detector Ld₂ of the link detecting device 316 receives the clock signal CK₂, the address signal A₂ and the command signal CMD₂ from the second bus Bus2. According to the clock signal CK₂, the link detector Ld₂ decodes the address signal A₂ and the command signal CMD₂. When the first circuit 310 confirms that the address signal A₂ contains the address of the first circuit 310 and the command signal CMD₂ contains the synchronous acknowledge message (SYC ACK), the first circuit 310 confirms that the second circuit 320 sends the link acknowledgement.

Please refer to FIG. 3C again. After the link acknowledgement is received, it means that the link between the second circuit 320 and the first circuit 310 has been established (Step S367). Meanwhile, the first circuit 310 can start to transmit data and commands to the second circuit 320 through the second bus Bus₁.

When the link is established, the receiver Rx2 of the second circuit 320 uses the select signal S₂ to control all multiplexers in the multiplexing device 322, and thus the data signal D₁, the address signal A₁, the clock signal CK₁ and the command signal CMD₁ are transmitted to the receiver Rx2 through the first bus Bus₁. Consequently, the data and the commands of the first circuit 310 can be outputted from the transmitter Tx1 and transmitted to the receiver Rx2 of the second circuit 320 through the first bus Bus₁. Furthermore, in order to terminate the connection, the first circuit 310 only needs to send a link termination to the second circuit 320 to terminate the link.

As mentioned in FIG. 3B and FIG. 3C, a three-way handshake process is required to establish the link between two circuits. For example, the second circuit 320 is the initiator, and the first circuit 310 is the target. The second circuit 320 transmits a link request to the first circuit 310 through the second bus Bus₂. Then, the first circuit 310 transmits a link acceptance to the second circuit 320 through the first bus Bus₁. Finally, the second circuit 320 transmits a link acknowledgement to the first circuit 310 through the second bus Bus₂, and the link between the second circuit 320 and the first circuit 310 is established. Consequently, the data and the commands of the second circuit 320 can be outputted from the transmitter Tx2 and transmitted to the receiver Rx1 of the first circuit 310 through the second bus Bus₂. In addition, the data and the commands of the first circuit 310 can be outputted from the transmitter Tx1 and transmitted to the receiver Rx2 of the second circuit 320 through the first bus Bus₁.

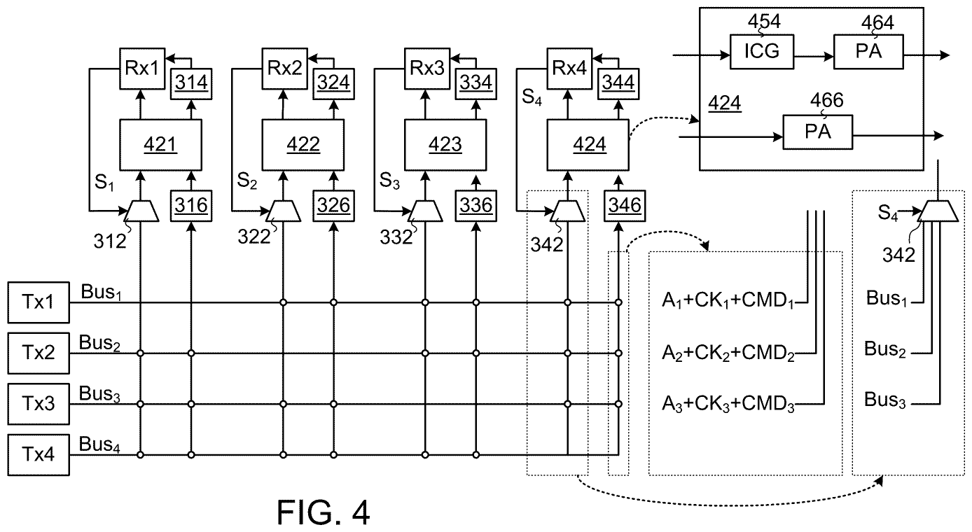

Hereinafter, the detailed circuitry structures will be described as follows. FIG. 4 schematically illustrates a simplified version of the architecture of the crossbar network shown in FIG. 3A. The architecture of the crossbar network shown in FIG. 4 is similar to the architecture of the crossbar network shown in FIG. 3A. In FIG. 4, the crossbar network further includes phase conversion devices 421, 422, 423 and 424. Similarly, the phase conversion devices 421, 422, 423 and 424 can also be respectively integrated into the corresponding receivers Rx1, Rx2, Rx3 and Rx4.

In this embodiment, the crossbar network includes four circuits (not shown). Similarly, the first circuit includes a transmitter Tx1 and a receiver Rx1, the second circuit includes a transmitter Tx2 and a receiver Rx2, the third circuit includes a transmitter Tx3 and a receiver Rx3, and the fourth circuit includes a transmitter Tx4 and a receiver Rx4. In addition, the link detecting device and the link allocation device in each circuit of FIG. 4 are integrated into the corresponding one of the receivers Rx1, Rx2, Rx3 and Rx4.

Furthermore, the transmitter of each circuit is connected to the corresponding bus. As shown in FIG. 4, the transmitter Tx1 of the first circuit is connected to a first bus Bus₁, the transmitter Tx2 of the second circuit is connected to a second bus Bus₂, the transmitter Tx3 of the third circuit is connected to a third bus Bus₃, and the transmitter Tx4 of the fourth circuit is connected to a fourth bus Bus₄.

Furthermore, the receiver of each circuit is coupled to all non-corresponding buses through the corresponding multiplexing device and the corresponding phase conversion device. Consequently, the receiver can be selectively coupled to one of the non-corresponding buses.

As shown in FIG. 4, the receiver Rx1 uses the select signal S₁ to control the multiplexing device 312, and thus the receiver Rx1 is selectively coupled to one of the second bus Bus₂, the third bus Bus₃ and the fourth bus Bus₄ according to the select signal S₁. Similarly, the receiver Rx2 uses the select signal S₂ to control the multiplexing device 322, and thus the receiver Rx2 is selectively coupled to one of the first bus Bus₁, the third bus Bus₃ and the fourth bus Bus₄ according to the select signal S₂. Similarly, the receiver Rx3 uses the select signal S₃ to control the multiplexing device 332, and thus the receiver Rx3 is selectively coupled to one of the first bus Bus₁, the second bus Bus₂ and the fourth bus Bus₄ according to the select signal S₃. Similarly, the receiver Rx4 uses the select signal S₄ to control the multiplexing device 342, and thus the receiver Rx4 is selectively coupled to one of the first bus Bus₁, the second bus Bus₂ and the third bus Bus₃ according to the select signal S₄.

Furthermore, each of the link detecting devices 316, 326, 336 and 346 is connected to all non-corresponding buses used to detect whether any other circuit initiates a link request. The link detecting devices 316, 326, 336 and 346 are coupled to the corresponding link allocation devices 314, 324, 334 and 344 through the phase conversion devices 421, 422, 423 and 424, respectively.

For example, the receiver Rx4 in the fourth circuit is coupled to all non-corresponding buses Bus₁, Bus₂ and Bus₃ through the phase conversion device 424 and the multiplexing device 342. In addition, the link allocation device 344 is coupled to all non-corresponding buses Bus₁, Bus₂ and Bus₃ through the phase conversion device 424 and the link detecting device 346. The link detecting device 346 receives the address signal A₁, the clock signal CK₁ and the command signal CMD₁ from the first bus Bus₁, receives the address signal A₂, the clock signal CK₂ and the command signal CMD₂ from the second bus Bus₂, and receives the address signal A₃, the clock signal CK₃ and the command signal CMD₃ from the third bus Bus₃.

When the receiver Rx4 is coupled to the first bus Bus₁, the phase conversion device 424 can ensure that the data signal D₁, the address signal A₁, the clock signal CK₁ and the command signal CMD₁ received by the receiver Rx4 are correct. That is, the phase conversion device 424 needs to remove the noise on the first bus Bus₁ and adjust the phases of the data signal D₁, the address signal A₁ and the command signal CMD₁ according to the clock signal CK₄. After the phases are adjusted, these signals are transmitted to the receiver Rx4. Consequently, it is ensured that the data signal D₁, the address signal A₁, the clock signal CK₁ and the command signal CMD₁ received by the receiver Rx4 are correct.

Similarly, the link allocation device 344 is coupled to the first bus Bus₁, through the phase conversion device 424 and the link detecting device 346 in order to ensure that the data signal D₁, the address signal A₁, the clock signal CK₁ and the command signal CMD₁ received by the receiver Rx4 are correct. Consequently, the link allocation device 344 can accurately detect the link request.

An example of the phase conversion device 424 will be described as follows. Please refer to FIG. 4. The phase conversion device 424 includes an integrated clock gating device (ICG device) 454 and two phase alignment devices (PA devices) 464 and 466. The ICG device 454 and the PA device 464 are coupled between the multiplexing device 342 and the receiver Rx4. The PA device 466 is coupled between the link detecting device 346 and the link allocation device 344. Before the receiver Rx4 is coupled to the first bus Bus₁, the ICG device 454 is disabled to temporarily isolate the clock signal CK₁ to prevent noise from being generated during the bus switching process. Then, the receiver RX4 controls the multiplexing device 342 to switch to the first bus Bus₁. Afterwards, the ICG device 454 is enabled, and thus the clock signal CK₁ is permitted to pass through the ICG device 454. Then, the clock signal CK₁, the data signal D₁, the address signal A₁ and the command signal CMD₁ from the first bus Bus₁ are aligned with the clock signal CK₄ by the PA device 464. Consequently, the receiver Rx4 can accurately receive all signals from the first bus Bus₁. The operations of the PA device 466 are similar, and not redundantly described herein.

Furthermore, the PA devices 464 and 466 can be replaced by clock domain crossing devices (CDC devices). The function of the CDC device is similar to the function of the PA device 464. By the CDC device, all signals from the first bus Bus₁ can be aligned with the clock signal CK₄.

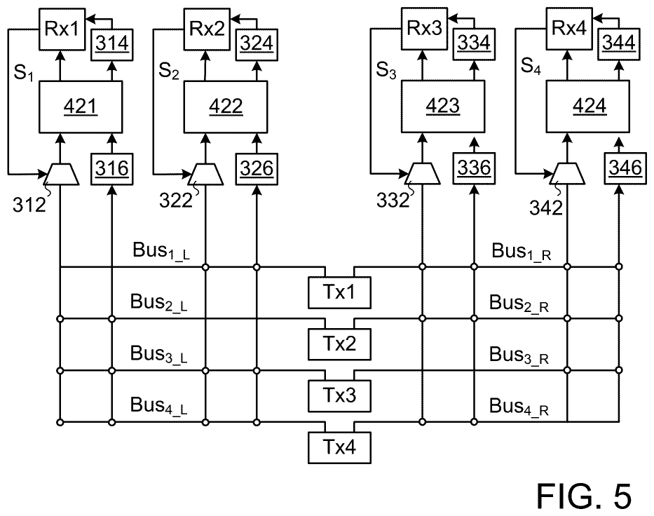

In order to reduce the power consumption, the bus in the crossbar network is modified. For example, the bus is divided into a plurality of parts. According to the locations of the initiator and the target, the transmitter of the circuit only sends signals to a part of the bus. FIG. 5 schematically illustrates the architecture of a crossbar network according to another embodiment of the present invention. In comparison with the crossbar network of FIG. 4, each of the four buses in the crossbar network of FIG. 5 is divided into two parts.

As shown in FIG. 5, the transmitter Tx1 is connected to the first bus left side part Bus_{1_L} and the first bus right side part Bus_{1_R}, the transmitter Tx2 is connected to the second bus left side part Bus_{2_L} and the second bus right side part Bus_{2_R}, the transmitter Tx3 is connected to the third bus left side part Bus_{3_L} and the third bus right side part Bus_{3_R}, and the transmitter Tx4 is connected to the fourth bus left side part Bus_{4_L} and the fourth bus right side part Bus_{4_R}. According to the locations of the initiator and the target, each of the transmitters Tx1, Tx2, Tx3 and Tx4 transmit signals through a part of each of the buses Bus₁, Bus₂, Bus₃ and Bus₄.

For example, the first circuit initiates a link request to the fourth circuit. After a three-way handshake process between the first circuit and the fourth circuit is performed, the data path is established. Firstly, the transmitter Tx1 of the first circuit sends a link request to the receiver Rx4 of the fourth circuit through the first bus right side part Bus_{1_R}. Then, the transmitter of the fourth circuit sends a link acceptance to the receiver Rx1 of the first circuit through the fourth bus left side part Bus_{4_L}. Afterwards, the transmitter Tx1 of the first circuit sends a link acknowledgement to the receiver Rx4 of the fourth circuit through the first bus right side part Bus_{1_R}. Consequently, the link between the first circuit and the fourth circuit is established.

After the link between the first circuit and the fourth circuit is established, the transmitter Tx1 of the first circuit sends data and commands to the receiver Rx4 of the fourth circuit through the first bus right side part Bus_{1_R}, and the transmitter Tx4 of the fourth circuit sends data and commands to the receiver Rx1 of the first circuit through the fourth bus left side part Bus_{4_L}. During the three-way handshake process and during the process of transmitting data and commands after link establishment, both of the first bus left side part Bus_{1_L} and the fourth bus right side part Bus_{4_R} are not used to transmit signals. Consequently, the power-saving efficacy of the crossbar network is enhanced.

In the above embodiments, each of the buses Bus₁, Bus₂, Bus₃ and Bus₄ can transmit four signals. However, each of the buses Bus₁, Bus₂, Bus₃ and Bus₄ can transmit more or less signals according to the practical requirements. For example, the address of the data signal D₁ and the address of the command signal CMD₁ are transmitted through the first bus Bus₁ according to the address signal A₁. In a variant example, two address signals are designed for the first bus Bus₁. The data address is transmitted according to one address signal, and the command address according to the other address signal. In another variant example, the data signal D₁, the address signal A₁ and the command signal C_{MD1} are combined into a general signal. Consequently, only the clock signal CK₁ and the general signal are transmitted through the first bus Bus₁.

Furthermore, the weight of the link priority in each of the link allocation devices 314, 324, 334 and 344 of the circuits 310, 320, 330 and 340 can be set according to the practical requirements. In an embodiment, the weights of the link priority about the link acknowledgement, the link acceptance and the link request are different according to settings. For example, the link acknowledgement has the highest weight of the link priority, the link acceptance has the second highest weight of the link priority, and the link request has the lowest weight of the link priority. According to the number of link failures, the circuits 310, 320, 330 and 340 may also adjust the weights of the link priorities. Furthermore, when the second circuit 320 receives the link termination, the weight of the link priority for linking the second circuit 320 to the first circuit 310 will be decreased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A crossbar network, comprising:
a first circuit comprising a first transmitter and a first receiver;
a second circuit comprising a second transmitter and a second receiver;
a first bus connected to the first transmitter of the first circuit;
a second bus connected to the second transmitter of the second circuit;
a first multiplexing device connected to the second bus, wherein the first receiver of the first circuit is coupled to the second bus through the first multiplexing device;
a second multiplexing device connected to the first bus, wherein the second receiver of the second circuit is coupled to the first bus through the second multiplexing device;
a first link detecting device coupled to the second bus, wherein when the second circuit initiates a link request to the first circuit, the first link detecting device detects the link request and notifies the first circuit through the second bus; and
a second link detecting device coupled to the first bus, wherein when the first circuit initiates the link request to the second circuit, the second link detecting device detects the link request and notifies the second circuit through the first bus.

2. The crossbar network as claimed in claim 1, further comprising:
a third circuit comprising a third transmitter and a third receiver;
a third bus connected to the third transmitter of the third circuit;
a third multiplexing device connected to the first bus and the second bus, wherein the third receiver of the third circuit is coupled to the first bus and the second bus through the third multiplexing device; and
a third link detecting device coupled to the first bus and the second bus, wherein when the first circuit initiates the link request to the third circuit, the third link detecting device detects the link request and notifies the third circuit through the first bus, wherein when the second circuit initiates the link request to the third circuit, the third link detecting device detects the link request and notifies the third circuit through the second bus.

3. The crossbar network as claimed in claim 2, wherein the first receiver of the first circuit is coupled to the third bus through the first multiplexing device, the second receiver of the second circuit is coupled to the third bus through the second multiplexing device, the first link detecting device is coupled to the third bus, and the second link detecting device is coupled to the third bus, wherein when the third circuit initiates the link request to the first circuit, the first link detecting device detects the link request and notifies the first circuit through the third bus, wherein when the third circuit initiates the link request to the second circuit, the second link detecting device detects the link request and notifies the second circuit through the third bus.

4. The crossbar network as claimed in claim 1, wherein the first circuit further comprises a first link allocation device, wherein when the first link detecting device detects the link request through the second bus, the first link allocation device determines whether a link between the first circuit and the second circuit is established according to a first link priority.

5. The crossbar network as claimed in claim 4, wherein the second circuit further comprises a second link allocation device, wherein when the second link detecting device detects the link request through the first bus, the second link allocation device determines whether the link between the first circuit and the second circuit is established according to a second link priority.

6. The crossbar network as claimed in claim 1, wherein when the first link detecting device detects the link request through the second bus, the first transmitter selectively sends a link acceptance to the first bus.

7. The crossbar network as claimed in claim 6, wherein if the link acceptance has not been received by the second circuit through the first bus for a specified time period, the second circuit confirms a link failure.

8. The crossbar network as claimed in claim 6, wherein after the link acceptance is received by the second circuit through the first bus, the second transmitter of the second circuit sends a link acknowledgement to the second bus, and a link between the first circuit and the second circuit is established.

9. The crossbar network as claimed in claim 8, wherein the second link detecting device of the second circuit detects the link acceptance through the first bus.

10. The crossbar network as claimed in claim 8, wherein the second receiver of the second circuit is coupled to the first bus under control of the second multiplexing device, and the second receiver of the second circuit detects the link acceptance from the first bus.

11. The crossbar network as claimed in claim 8, wherein the first link detecting device of the first circuit detects the link acknowledgement through the second bus.

12. The crossbar network as claimed in claim 8, wherein the first multiplexing device is coupled to the second bus under control of the first receiver of the first circuit, and the first receiver of the first circuit detects the link acknowledgement through the second bus.

13. The crossbar network as claimed in claim 8, wherein when the link between the first circuit and the second circuit is established, the first multiplexing device is coupled to the second bus under control of the first receiver of the first circuit, and the second multiplexing device is coupled to the first bus under control of the second receiver of the second circuit, wherein the first transmitter of the first circuit transmits a first data signal, a first address signal, a first clock signal and a first command signal to the second receiver of the second circuit through the first bus, and the second transmitter of the second circuit transmits a second data signal, a second address signal, a second clock signal and a second command signal to the first receiver of the first circuit through the second bus.

14. The crossbar network as claimed in claim 13, wherein when the second circuit initiates the link request to the first circuit, the second address signal contains an address of the first circuit, and the second command signal contains a synchronous message.

15. The crossbar network as claimed in claim 13, wherein when the first transmitter of the first circuit sends the link acceptance to the first bus, the first address signal contains an address of the second circuit, and the first command signal contains a synchronous acceptance message.

16. The crossbar network as claimed in claim 13, wherein when the second transmitter of the second circuit sends the link acknowledgement to the second bus, the second address signal contains an address of the first circuit, and the second command signal contains a synchronous acknowledge message.

17. The crossbar network as claimed in claim 13, wherein when the first circuit sends a link termination to the second circuit through the first bus, the link between the first circuit and the second circuit is terminated, wherein when the second circuit sends the link termination to the first circuit through the second bus, the link between the first circuit and the second circuit is terminated.

18. The crossbar network as claimed in claim 13, wherein the first link detecting device is coupled to the second bus through a phase conversion device so as to receive the link request.

19. The crossbar network as claimed in claim 13, wherein the first receiver is coupled to the second bus through the first multiplexing device and a phase conversion device, and the phase conversion device adjusts the second data signal, the second address signal and the second command signal according to the first clock signal.

20. The crossbar network as claimed in claim 19, wherein the phase conversion device comprises an integrated clock gating device connected to the first multiplexing device and a phase alignment device connected between the integrated clock gating device and the first receiver, or the phase conversion device comprises an integrated clock gating device connected to the first multiplexing device and a clock domain crossing device connected between the integrated clock gating device and the first receiver.
